(19) United States
(12) Patent Application Publication
(10) Pub. No.: US 2006/0028493 A1
(43) Pub. Date: Feb. 9, 2006

(54) Image display device

(75) Inventors: Tetsuya Shimoda, Tokyo (JP); Tsutomu Kume, Ibaraki (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/188,892

(22) Filed: Jul. 26, 2005

(30) Foreign Application Priority Data
Aug. 4, 2004 (JP) P2004-227438

(51) Int. Cl. G09G 5/10

(52) U.S. Cl. 345/690

(57) ABSTRACT

The present invention relates to an image display device which can be applied to an electronic still camera, for example. The image display device has a single circuit for processing of image data for display that can be used in common for liquid crystal display units which are different in arrangement of color filters. The image display device according to the present invention sequentially selects color data (DR, DG, DB) and corrects phase characteristics and sends out the results. It permits the order of color data selection and phase characteristics to be established as desired.

### CROSS REFERENCES TO RELATED APPLICATIONS

The present invention contains subject matter related to Japanese Patent Application No. 2004-227438 filed in the Japanese Patent Office on Aug. 4, 2004, the entire contents of which being incorporated herein by reference.

### BACKGROUND OF THE INVENTION

1. Field of the Invention

The present invention relates to an image display device which can be applied to an electronic still camera, for example. The image display device according to the present invention sequentially selects color data and corrects phase characteristics and sends out the results. It permits the order of color data selection and phase characteristics to be established as desired. Consequently, it has a single circuit for processing of image data for display that can be used in common for liquid crystal display units which are different in arrangement of color filters.

2. Description of the Related Art

Any conventional imaging device, such as an electronic still camera and video camera, has a built-in liquid crystal display panel or a means for connection to an external monitor, so that images taken by it can be confirmed by the user.

FIG. 6 is a block diagram showing the construction of a conventional liquid crystal display device to be driven by analog signals. The display device 1 has a digital signal processor (DSP) 2, which receives image data D1 for display and processes them for conversion into analog signals (color signals SR, SG, and SB) and then sends them out together with timing signals. In other words, the digital signal processor 2 includes a display signal processing unit 3 and a digital-analog conversion circuit (D/A) 4. The display signal processing unit 3 receives image data D1 (composed of red, green, and blue color data each in 8 bits) and performs processing (such as gamma correction and contour correction) on them and sends out processed results. The digital-analog conversion circuit (D/A) 4 performs digital-analog conversion on the image data which has been sent out from the display signal processing unit 3, thereby generating color signals SR, SG, and SB, which are analog signals. The digital signal processor 2 sends out these color signals SR, SG, and SB together with the horizontal synchronizing signal HD and vertical synchronizing signal VD.

The driving circuit 6 is constructed with integrated circuits; it drives the liquid crystal display panel by means of these color signals SR, SG, and SB and the horizontal synchronizing signal HD and vertical synchronizing signal VD. In other words, the driving circuit 6 includes the timing generator (TG) 8 and the RGB driver 9. The former generates and sends out timing signals (such as horizontal synchronizing signal HD and vertical synchronizing signal VD) to drive the liquid crystal display panel 7. The latter amplifies and sends out the color signals SR, SG, and SB.

The liquid crystal display panel 7 includes the TFT (thin film transistor) liquid crystal display unit 10 (having pixels arranged in a matrix pattern) and the vertical driving circuit 11 and the horizontal driving circuit 12 (which are integrally formed on a glass substrate). In this liquid crystal display panel 7, the vertical driving circuit 11 drives the gate lines of the display unit 10 according to timing signals received from the driving circuit 6, thereby sequentially selecting line by line the pixels in the display unit 10. The horizontal driving circuit 12 sequentially samples the color signals SR, SG, and SB (received from the driving circuit 6) according to timing signals received from the driving circuit 6 and distributes them to individual signal lines of the display unit 10, thereby driving individual signal lines with color signals SR, SG, and SB.

Incidentally, the display unit 10 is available in two types according to the arrangement of pixels therein. The first type, called stripe arrangement type, has red, green, and blue pixels which are sequentially repeated in the horizontal direction in such a way that pixels of the same color are repeated in the vertical direction, as shown in FIG. 7. Whereas, the second type, called delta arrangement type, has red, green, and blue pixels which are arranged in the following manner. Pixels in the odd-number lines are displaced (relative to the even-number lines) in the horizontal direction by half a pixel pitch, so that the set of red, green, and blue pixels is repeated differently from one line to its adjacent line, as shown in FIG. 8. The delta arrangement type is further divided into two subtypes. The first subtype has dummy pixels (D) at the scan starting end (of the odd-number line) and the scan terminating end (of the even-number line), so that pixels of the same color are connected to one signal line (SIG), as shown in FIG. 9. The second subtype does not have the dummy pixels (D) and pixels of different colors (continuous in the vertical direction) are connected to one signal line (SIG), as shown in FIG. 10.

As mentioned above, the conventional liquid crystal display device 1 driven by analog signals has the driving circuit 6, the vertical driving circuit 11, and the horizontal driving circuit 12 which are designed exclusively for the display unit 10. In addition, it has the timing generator 8 which generates various timing signals for the horizontal driving circuit 12 and sets up the sampling timing of color signals (R, G, B) for the signal lines (SIG) and also sets up what to sample for the signal lines (SIG).

The liquid crystal display device 1 is designed such that the display unit 10 shows an image with a correct orientation (in both the vertical and horizontal directions) when the display unit 10 to be monitored is turned 180 degrees with respect to the imaging means. This is accomplished by switching the action of the horizontal driving circuit 12 and the action of the vertical driving circuit 11 from each other in response to the control signal. This switching is called Horizontal-inversion and Vertical-inversion. The former switches the distribution of color signals in the horizontal driving circuit 12, and the latter switches the order of driving the gate lines in the vertical driving circuit 11.

There has recently become commercially available a liquid crystal display device of stripe arrangement type which is driven by digital signals as shown in FIG. 11. In the liquid crystal display device 21, the digital signal processor 22 receives the image data D1 which is composed of red, green, and blue color data DR, DG, and DB (with 8 bits each). The signal processing circuit 23 in the digital signal processor 22 processes these color data and sends out the processed data (with 8 bits each). See FIGS. 12(A), 12(B), and 12(C). Thus, the digital signal processor 22 sends out the image data D2 together with the channel clock CK, the horizontal synchronizing signal HD, and the vertical synchronizing signal VD.

The liquid crystal display panel 24 consists of the display unit 25 (of stripe arrangement type), the vertical driving circuit 26, and the horizontal driving circuit 27, which are integrally formed on a single glass substrate. In the liquid crystal display panel 24, the vertical driving circuit 26 selects line by line individual pixels in the display unit 25 according to timing signals (such as horizontal synchronizing signal HD) received from the digital signal processor 22, and the horizontal driving circuit 27 distributes the image data D2 (which is sequentially received from the built-in shift register) sequentially to signal lines, thereby performing digital-analogy conversion and driving individual signal lines.

Improvements have been made on the liquid crystal display device 21 of stripe arrangement type to be driven by digital signals. Such improvements include a method for preventing color shift (disclosed in Japanese Patent Laid-open No. Hei-9-212131) and a method for driving the liquid crystal display panel.

By the way, if there is a liquid crystal display device of delta arrangement type that can be driven by digital signals, it would run with less power than the one driven by analog signals and it would be simple in construction and hence permit miniaturization. In this case, if the digital signal processor (as the circuit to process the image data D1) can be used in common for both the delta arrangement type and the stripe arrangement type, then it would be possible to reduce the period required for development.

Patent Document 1: Japanese Patent Laid-open No. Hei-9-212131.

### OBJECT AND SUMMARY OF THE INVENTION

The present invention was completed in view of the foregoing. Thus, it is an object of the present invention to provide an image display device in which the circuit to process image data for display can be used in common for display units which are different in the arrangement of color filters.

The first embodiment of the present invention resides in an image display device designed to display an image on the display unit including pixels arranged in a matrix pattern, the image display device including a selector configured to sequentially select red, green, and blue color data in a prescribed order and then send them out, and a phase correcting circuit configured to correct and send out the phase of each color data sent out from the selector, the selector including selection-order setting means for setting the order of selection in such a way that the order of selection corresponds to the arrangement of pixels in the display unit, the phase correcting circuit including characteristics setting means for setting the characteristics to correct the phase of the color data in such a way that the spatial phase of the color data corresponds to the arrangement of pixels in the display unit.

The second embodiment of the present invention resides in an image display device designed to send out image data to the display unit including pixels arranged in a matrix pattern, thereby displaying an image on the display unit, the image display device including a selector configured to sequentially select red, green, and blue color data in a prescribed order and then send them out, and a phase correcting circuit configured to correct and send out the phase of each color data sent out from the selector, the selector including selection-order setting means for setting the order of selection in such a way that the order of selection corresponds to the arrangement of pixels in the display unit, the phase correcting circuit including characteristics setting means for setting the characteristics to correct the phase of the color data in such a way that the spatial phase of the color data corresponds to the arrangement of pixels in the display unit.

The image display device as defined in the first embodiment of the present invention is designed to display an image on the display unit including pixels arranged in a matrix pattern. The image display device includes a selector configured to sequentially select red, green, and blue color data in a prescribed order and then send them out, and a phase correcting circuit configured to correct and send out the phase of each color data sent out from the selector, the selector including selection-order setting unit configured to set the order of selection in such a way that the order of selection corresponds to the arrangement of pixels in the display unit, the phase correcting circuit including characteristics setting means configured to set the characteristics to correct the phase of the color data in such a way that the spatial phase of the color data corresponds to the arrangement of pixels in the display unit. Owing to the actions mentioned above, the image display device of the present invention sends out each color data in the order corresponding to the arrangement of pixels conforming to the arrangement of color filters and corrects the phase of each color data to display the image on the display unit. This construction makes it possible to use the circuit to process image data for display in common for display units which are different in the arrangement of color filters.

The image display device as defined in the second embodiment of the present invention is designed to send out image data to the display unit including pixels arranged in a matrix pattern, thereby displaying an image on the display unit. The image display device constructed as mentioned above makes it possible to use the circuit to process display image data in common for display units which are different in the arrangement of color filters.

The image display device according to the present invention makes it possible to use the circuit to process display image data in common for display units which are different in the arrangement of color filters.

Other and further objects, features and advantages of the invention will appear more fully from the following description.

### BRIEF DESCRIPTION OF THE DRAWINGS

FIG. 1 is a block diagram showing the driving circuit for the electronic still camera pertaining to one embodiment of the present invention;

FIG. 2 is a block diagram showing the electronic still camera pertaining to one embodiment of the present invention;

FIG. 3 is a block diagram showing the display signal processing circuit for the electronic still cameral shown in FIG. 2;

FIG. 4 is a timing chart to illustrate the action of the driving circuit shown in FIG. 1 which is applicable when the display unit is of delta arrangement type;

FIG. 5 is a timing chart to illustrate the action of the driving circuit shown in FIG. 1 which is applicable when the display unit is of stripe arrangement type;

FIG. 6 is a block diagram showing the conventional liquid crystal display device which is driven by analog signals;

FIG. 7 is a plan view showing the stripe arrangement;

FIG. 8 is a plan view showing the delta arrangement;

FIG. 9 is a plan view showing the wiring for pixels of identical colors;

FIG. 10 is a plan view showing the wiring for pixels of different colors;

FIG. 11 is a block diagram showing the conventional liquid crystal display device which is driven by digital signals; and

FIG. 12 is a timing chart to illustrate the action of the display device shown in FIG. 11.

### DESCRIPTION OF THE PREFERRED EMBODIMENTS

The embodiments of the present invention will be described in more detail with reference to the accompanying drawings.

### (1) Embodiment 1—Construction

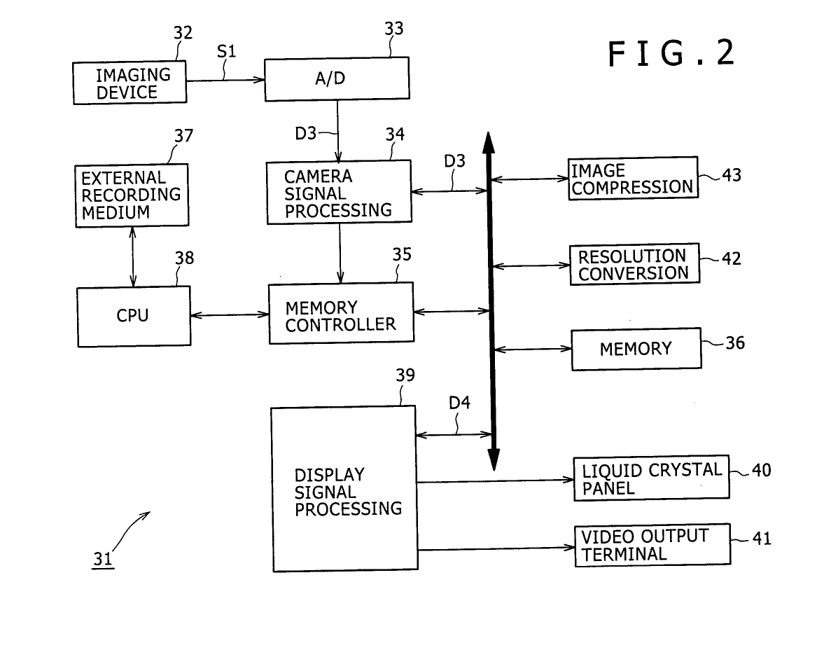

FIG. 2 is a block diagram showing the electronic still camera pertaining to Embodiment 1 of the present invention. The electronic still camera 31 has an imaging device 32, which may be a CCD (Charge Coupled Device) solid-state imaging device, for instance. The CCD works in response to timing signals supplied from the driving circuit (not shown) and sends out the image signal S1 for VGA (Video Graphic Array) composed of 640×480 pixels, for instance.

The analog-digital conversion circuit (A/D) 33 performs analog/digital conversion on the image signal S1 and then sends out the resulting image data D3. The camera signal processing circuit 34 performs white balance adjustment and gamma correction on the image data D3 and converts them into luminance data and color difference data (of 4:2:2 format) and sends out the results to the memory controller 35.

The memory controller 35 at the time of photographing receives the image data from the analog-digital converting circuit 33 and sends them out to the image data bus (BUS) so that the image data is sequentially recorded in the memory 36. By contrast, the memory controller 35 at the time of monitoring the image recorded in the external recording medium 37 receives the image data from the central processing unit (CPU) 38 and sends them out to the image data bus (BUS). When the user instructs to copy the image data recorded in the memory 36 to the external recording medium 37, the memory controller 35 sends the image data (to be sent to the image data bus (BUS)) to the central processing unit 38.

The memory 36 is a so-called image memory; it records and sends out the image data for display. The display signal processing circuit 39 drives the liquid crystal display panel 40 in response to the image data from the memory 36. Moreover, it sends out video signals through the video output signal terminal 41. Thus, the electronic still camera 31 permits the user to recognize on the liquid crystal display panel 40 the image obtained by the imaging device 32 or recorded in the external recording medium 37.

Upon the user's instruction to copy the image data recorded in the memory 36 to the external recording medium 37, the resolution converting circuit 42 sequentially acquires the image data recorded in the memory 36 and changes the resolution into the one specified by the user and finally sends out the converted image data to the image compression circuit 43 through the image data bus (BUS). These steps are accomplished under control by the central processing unit 38. The reverse process takes place when the user instructs to monitor the image recorded in the external recording medium 37. In this case, the resolution conversion circuit 42 acquires the image data from the image compression circuit 43 through the image data bus (BUS) and restores the original resolution and sends the result to the memory 36.

Upon the user's instruction to copy the image data recorded in the memory 36 to the external recording medium 37, the image compressing circuit 43 sequentially acquires the image data from the resolution converting circuit 42 and compresses the image data and sends them out to the memory controller 35 through the image data bus (BUS). These steps are accomplished under control by the central processing unit 38. The reverse process takes place when the user instructs to monitor the image recorded in the external recording medium 37. In this case, the image compressing circuit 43 acquires the image data from the memory controller 35 and expands the image data and sends them out to the resolution converting circuit 42 through the image data bust (BUS).

The external recording medium 37 may be a memory card, for example; it records and holds image data (resulting from photographing) under control by the central processing unit 38. It also sends out the image data (recorded and held therein) to the central processing unit 38.

The central processing unit 38 executes prescribed programs and controls the action of the electronic still camera 31 in response to the user's operation. Under normal operation, it generates the image data D3 from the imaging signal S1 produced by the imaging device 32 and then sequentially records them in the memory 36. It also controls the entire action so as to drive the liquid crystal display panel 40 according to the image data recorded in the memory 36. Upon the user's instruction to record the result of photographing, the central processing unit 38 causes the resolution converting circuit 42 and the image compressing circuit 43 to perform resolution conversion and data compression on the image data held in the memory 36. Then it acquires the processed results and causes the external recording medium 37 to record them. Upon the user's instruction to monitor the image data recorded in the external recording medium 37, it reads the corresponding image data from the external recording medium 37 and causes the image compressing circuit 43 and the resolution converting circuit 42 to perform data expansion and resolution conversion and then causes the processed image data to be recorded in the memory 36 and displayed on the liquid crystal panel 40.

In the way mentioned above, the electronic still camera 31 permits the image data to be monitored on the liquid crystal display panel 40 and records (keeps) the desired results of photographing in the external recording medium 37. It also permits the results of photographing (recorded in the external recording medium 37) to be monitored.

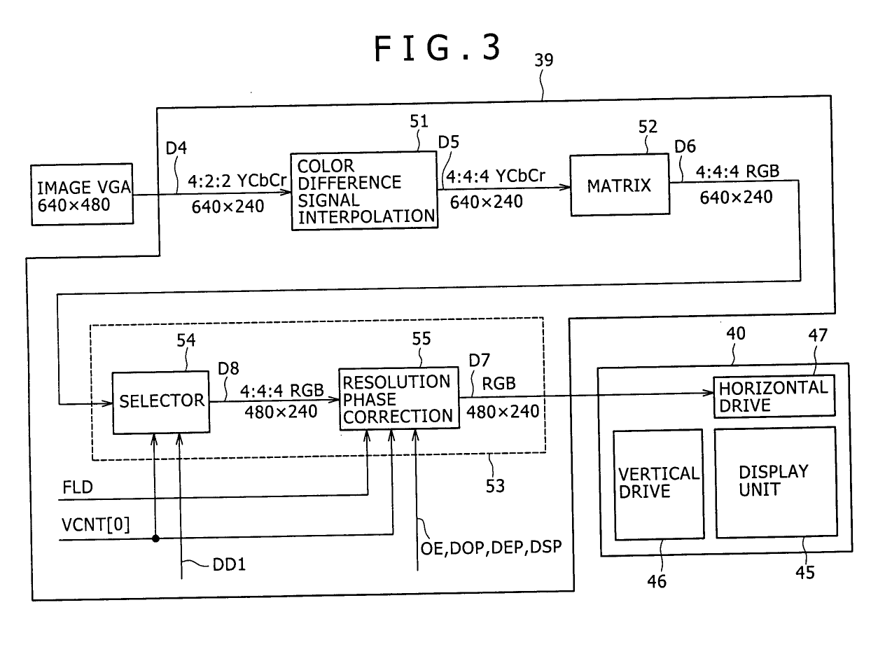

FIG. 3 is a block diagram showing the display signal processing circuit 39 and the liquid crystal display panel 40. The liquid crystal display panel 40 in the electronic still camera 31 consists of the display unit 45, the vertical driving circuit 46, and the horizontal driving circuit 47, which are integrally formed on a single glass substrate. (The display unit 45 is of the delta arrangement type in which pixels of identical colors are wired or pixels of different colors are wired.) Here, the vertical driving circuit 46 sequentially selects pixels in the display unit 45 line by line according to the timing signal supplied from the display signal processing circuit 39. The horizontal driving circuit 47 sequentially latches the image data D7 supplied from the display signal processing circuit 39 by the built-in shift register according to the timing signal supplied from the display signal processing circuit 39. In this way they sequentially distribute the image data D7 among the signal lines of the display unit 45. In addition, they also perform digital-analog conversion on the thus distributed image data D7, thereby generating drive signals for individual signal lines, so that these driving signals drive the individual signal lines.

In the liquid crystal display panel 40, the vertical driving circuit 46 inverts the order of selection of the lines in the display unit 45 when the central processing unit 38 issues an instruction for Vertical-inversion. The horizontal driving circuit 47 inverts the order of distribution of the input image data D7 for the signal lines when the central processing unit 38 issues an instruction for Horizontal-inversion. In this way, the order of driving pixels in the display unit 45 is inverted so that the liquid crystal display panel 40 is capable of Vertical-inversion and Horizontal-inversion.

The display signal processing circuit 39 includes the digital signal processor. It receives the image data D4 (with interlace scanning) including luminance data and color difference data in 4:2:2 format from the memory 36 through the image data bus (BUS). In this display signal processing circuit 39, the color difference interpolating circuit 51 converts the image data D4 in 4:2:2 format into the image data D5 in 4:4:4 format by means of interpolation processing, and the ensuing matrix circuit 52 converts the image data D5 composed of luminance data and color difference data into the image data D6 composed of red, green, and blue color data by matrix arithmetic processing.

In the driving circuit 53, the selector 54 sequentially selects (according to a predetermined selecting order) the red, green, and blue color data which are entered in parallel simultaneously from the matrix circuit 52 and sends out the result to the resolution phase correcting circuit 55. The resolution phase correcting circuit 55 corrects, for each color data, the phase of the color data which is sent out from the selector 54, and then sends out the result. In this way, the driving circuit 53 generates the image data D7 to be used to drive the liquid crystal display panel 40 and sends it out to the liquid crystal display panel 40. The driving circuit 53 can change, according to the set value in the register, the order of selecting color data and the characteristics of phase correction (which is determined by the resolution phase correcting circuit 55) for the display panel of stripe arrangement type or for the display panel of delta arrangement type. Therefore, this embodiment can drive the liquid crystal display panel 40 of delta arrangement type by using the circuit to process the image data for the liquid crystal display panel of stripe arrangement type.

In other words, the selector 54 detects in each field the start line of the active image period at which color data is selected and output according to the count value (VCNT) of the horizontal synchronizing signal based on the vertical synchronizing signal, and then it starts the selection and output of color data from the start line. Incidentally, the start line may be the 22nd line in the odd-number field and the 285th line in the even-number field.

Also, the selector 54 initializes each bit of the pixel arrangement set point DD1 (as one of the set point in the register) and counts the channel clock CK of the image data D7 for each color data. In this way it sequentially selects and outputs the color data according to the set point in the register so that the color data corresponds to the pixel arrangement of the liquid crystal display panel 40.

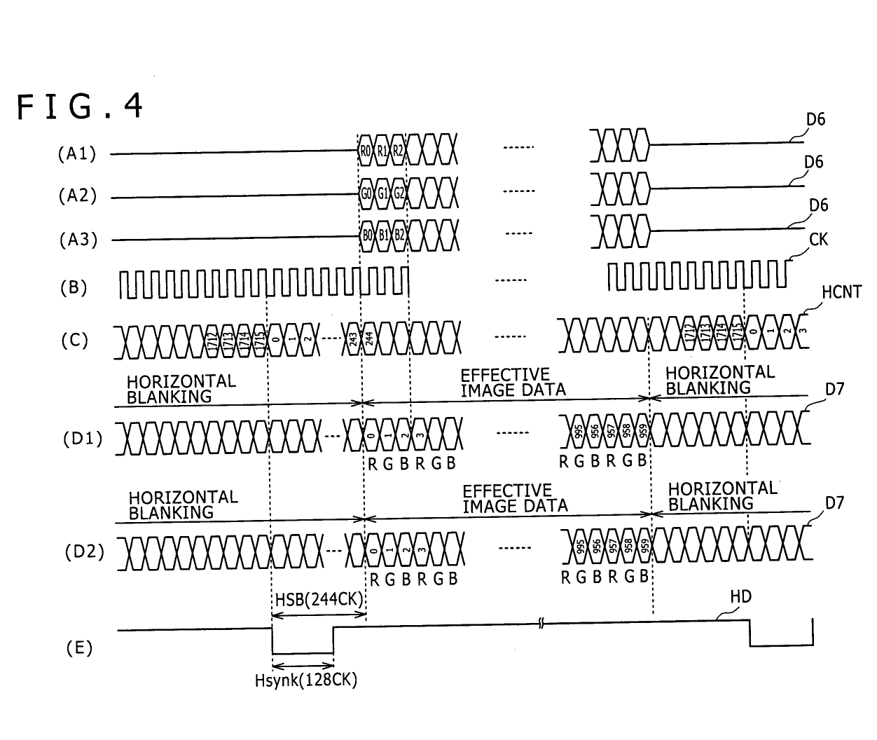

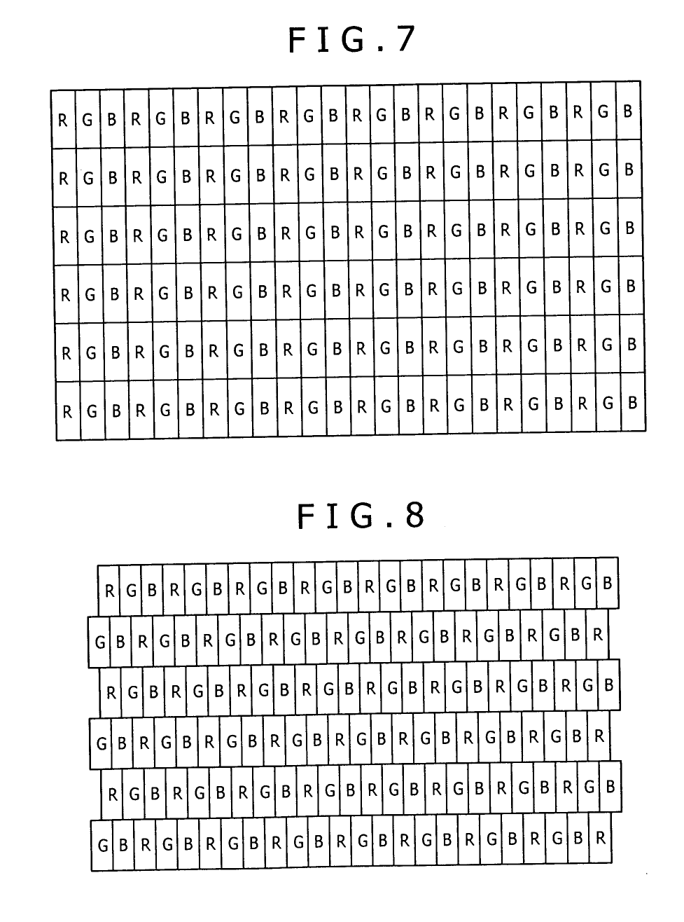

That is, in the case of the liquid display panel 40 of stripe arrangement type as shown in FIG. 7, the selector 54 sequentially selects and outputs the color data in the order of red, green, and blue (as shown in FIGS. 4(D1) and 4(D2)) in both the even-number lines and the odd-number lines in synchronism with the channel clock CK (shown in FIG. 4(B)) of the image data D6 (shown in FIGS. 4(A1) to (A3)) for red, green, and blue colors. At this time, the selector 54 samples and outputs the color data of red, green, and blue at an interval of ⅓ cycle of the channel clock CK. Thus it outputs the color data of red, green, and blue after decimation (with the spatial phase remaining unchanged) in the order of R0, G0, B0, R3, G3, B3, R6, G6, B6, . . . for the image data D6 composed of the red color data R0, R1, R2, R3, R4, . . . , green color data G0, G1, G2, G3, G4, . . . , and blue color data B0, B1, B2, B3, B4, . . .

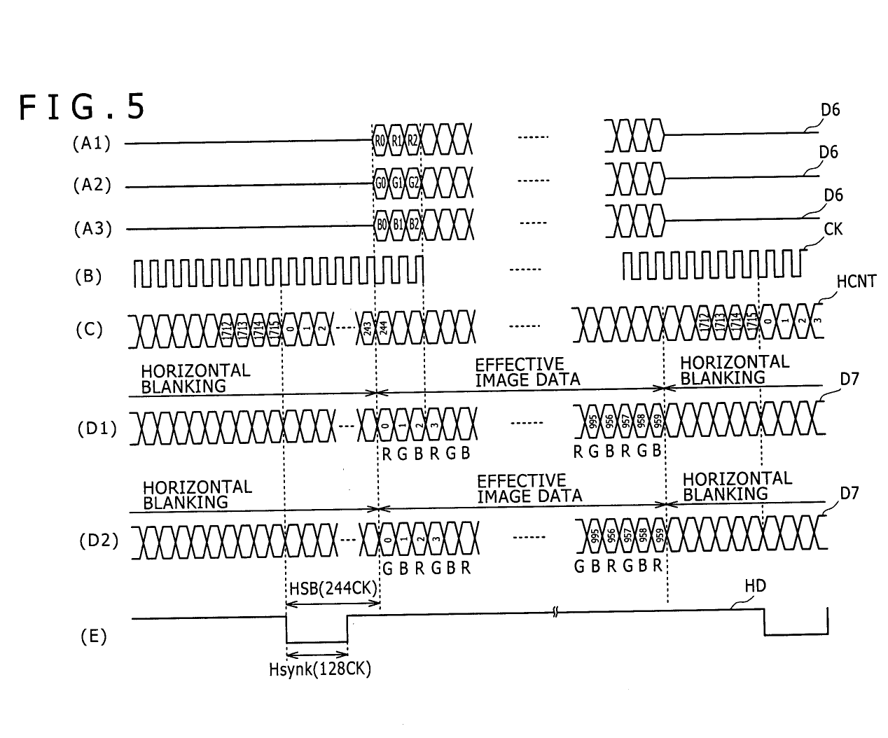

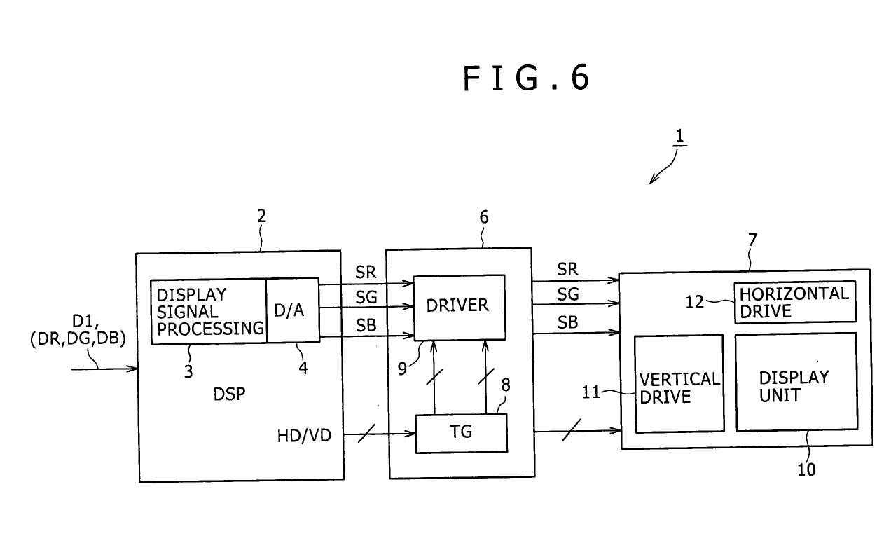

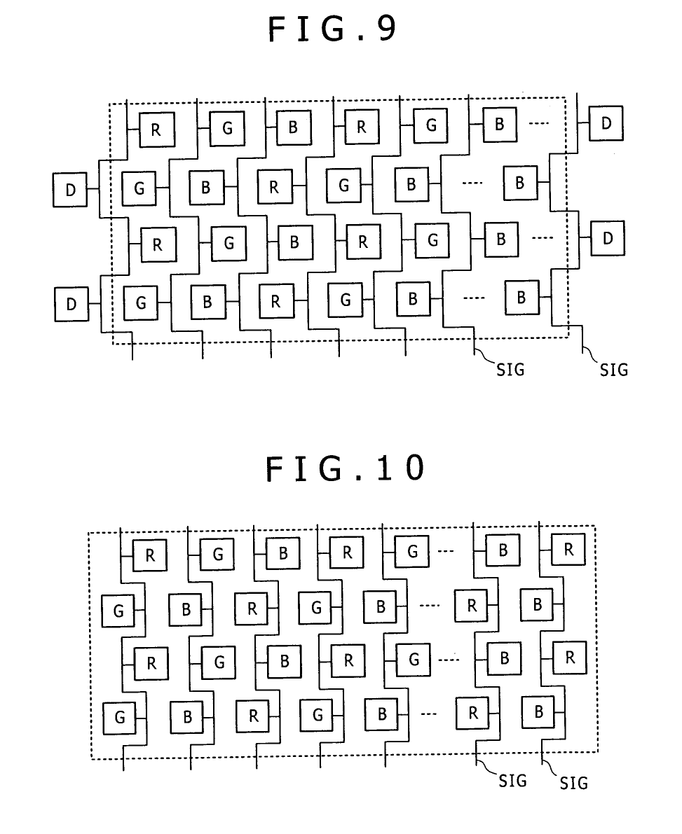

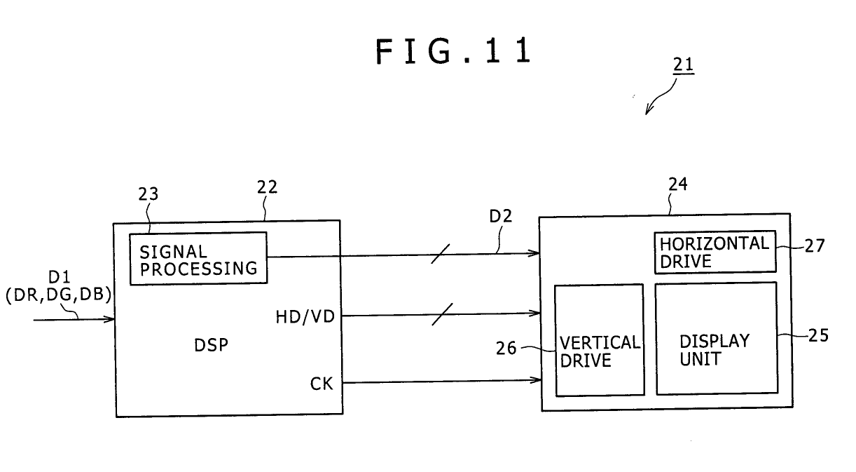

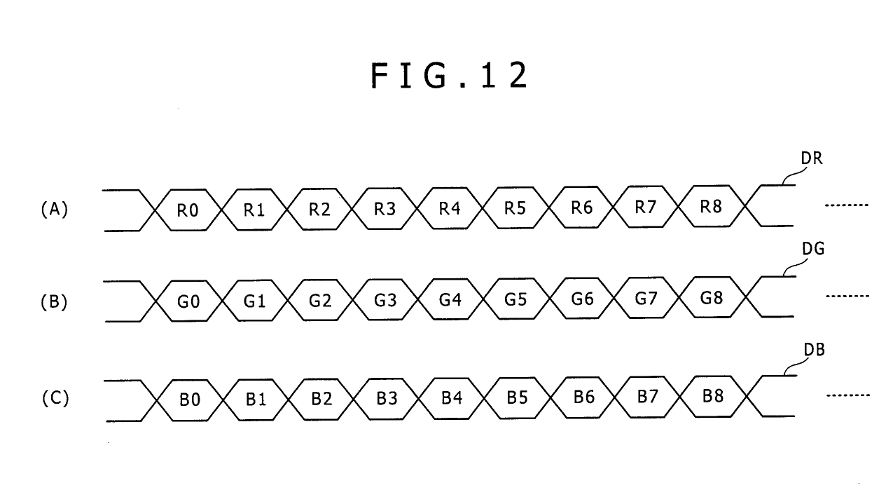

By contrast, in the case of the liquid display panel 40 of delta arrangement type as shown in FIG. 8 and in the case of the liquid crystal panel 40 with wiring for identical colors as shown in FIG. 9, the selector 54 outputs the color data in the same order as in the case of the liquid crystal display panel 40 of stripe arrangement type. In this case, dummy image data is allocated to the scan terminating end and the scan starting end in odd-number lines and even-number lines, respectively, according to the line judgment. On the other hand, in the case of the liquid crystal display panel 40 of delta arrangement type and in the case of the liquid crystal panel 40 with wiring for different colors as shown in FIG. 10, the selector 54 outputs the color data (as shown in FIG. 5(D1)) in the same way as in the case of the liquid crystal display panel 40 of stripe arrangement type for the odd-number lines according to the channel clock CK (as shown in FIG. 5(B)) of the image data D6 (as shown in FIGS. 5(A1) to 5(A3)). However, the selector 54 outputs the color data in a different order for even-number lines, that is, in the order of green color data, blue color data, and red color data (as shown in FIG. 5(D2)). In these processes, the selector 54 sequentially samples and outputs the color data of red, green, and blue according to the channel clock CK, so that the selector 54 outputs the color data of red, green, and blue after decimation (with the spatial phase remaining unchanged) in the order of R0, G1, B2, R3, G4, B5, R6, G7, B8, . . . for the image data D6 composed of the red color data R0, R1, R2, R3, R4, . . . , green color data G0, G1, G2, G3, G4, . . . , and blue color data B0, B1, B2, B3, B4, . . .

The resolution phase correcting circuit 55 has the FIR filter 57 and the normalizing operator 61, which respectively correct the resolution and phase of the color data D8 which is sequentially output in the order corresponding to the arrangement of pixels in the liquid crystal panel 40. Thus it sends out the color data D7 with the spatial phase corresponding to the arrangement of pixels in the liquid crystal display panel 40.

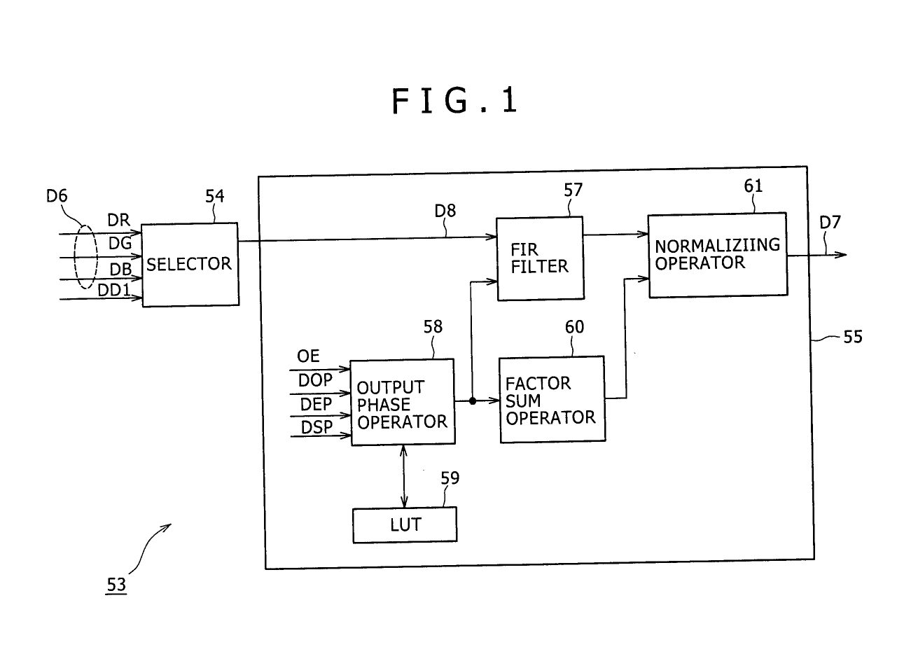

As shown in FIG. 1, the resolution phase correcting circuit 55 has the output phase operator 58, which generates the correcting factor for phase correction for each pixel according to the spatial phase in the pixel at the horizontal scan starting end of the liquid crystal panel 40 (which is set up in the register) based on the discriminating signal OE to discriminate between the even-number line and the odd-number line. Now, this embodiment is designed such that the spatial phase for the pixel at the scan starting end can be set up separately for the odd-number line and the even-number line on the basis of the sampling cycle of the input image data D6 according to the odd-line initial phase set point DOP or the even-line initial phase set point DEP. Moreover, this embodiment makes it possible to set up in the register the sampling cycle of the output image data D7 by means of the output sampling interval set point DSP on the basis of the sampling cycle of the input image data D6.

Thus, the output phase operator 58 sequentially computes the phase difference in samples corresponding to the input image data D6 for each sample of the output image data D7 based on these set points DOP, DEP, and DSP. It also searches the look-up table (LUP) 59 according to the thus computed phase difference, thereby detecting the correcting factor.

Here, the look-up table 59 holds the factor data to be set in the FIR filter 57 for each phase difference computed by the output phase operator 58, and it sends out as the correcting factor the corresponding factor data as the output phase operator 58 accesses according to the phase difference.

By contrast, the FIR filter 57 possesses a plurality of delay circuits that sequentially delay the image data D8 which is output from the selector 54. The delay circuit adds the color data of continuous five samples to each color according to the correcting factor sent out from the output phase operator 58 and sends out the result.

The factor scan operator 60 adds the correction factor to be set in the FIR filter and sends out the result of addition, and the normalizing operator 61 divides the output data of the FIR filter 57 by the result of addition and sends out the result. In this way, the resolution phase correcting circuit 55 converts the resolution of the image data D6 which is sequentially output from the selector 54 into the resolution corresponding to the liquid crystal display panel 40. Also, in this processing, it corrects the spatial phase of each color data constituting the output image date D6 into the spatial phase of the pixel corresponding to the liquid crystal display panel 40.

The display signal processing circuit 39 sets up the register's set point in the selector 54 and the resolution phase correcting circuit 55 in correspondence to Vertical-inversion and Horizontal-inversion. In this way the selector 54 sequentially selects color data so that it corresponds to the scanning order in the line direction in the inverted display unit 45 in the case of Horizontal-inversion or it changes the order of selection for the even-number line for the order of selection for the odd-number line in the case of Vertical-inversion. It also changes the correction of spatial phase in the resolution phase correcting circuit 55 so that the change corresponds to the change of scanning order necessitated by Vertical-inversion and Horizontal-inversion.

To implement the forgoing, the electronic still camera 31 has a memory (not shown) which records the set point for each register in the display signal processing circuit 39 at the time of manufacture. When the electronic still camera 31 is turned on, the central processing unit 38, which controls the action of the electronic still camera 31, loads the set point recorded in the memory, thereby setting it in the register corresponding to the display signal processing circuit 39.

### (2) Embodiment 1—Action

The components (shown in FIG. 2) of the electronic still camera 31 work as follows. The analog-digital converting circuit 33 receives the result of photographing from the imaging device 32 and then converts it into the image data. The camera signal processing circuit 34 performs gamma correction etc. on this image data. The camera signal processing circuit 34 sends out the image data, which is recorded in the memory 36 by the memory controller 35. The image data D3 (or the result of photographing) recorded in the memory 36 is copied to the external recording medium 37 through the memory controller 35 and the central processing unit 38, with its resolution converted as desired by the resolution converting circuit 42 and its data size compressed by the image compressing circuit 43. The image data recorded in the external recording medium 37 in this way is also copied to the memory 36 after processing in the order opposite to that employed at the time of recording. The image data D3 recorded in the memory 36 is processed by the display signal processing circuit 39 and then used to drive the liquid crystal display panel 40. Thus, the electronic still camera 31 permits the user to monitor on the liquid crystal display panel 40 the result of photographing obtained from the imaging device 32 and the result of photographing recorded in the external recording medium 37.

The components (shown in FIG. 3) of the electronic still camera 31 work as follows. The memory 36 stores the image data D4 (or the result of photographing) in the form of luminance data and color difference data. The image data D4 is entered in the display signal processing circuit 39 which includes the color difference signal interpolating circuit 51 and the matrix circuit 52. The former performs interpolation on the color difference data, thereby generating the image data D5, and the latter changes the image data D5 into the image data D6 composed of red, green, and blue color data. The driving circuit 53 performs time sharing and multiplexing on each color data of the image data D6 and sends out the result, together with timing signals, to the liquid crystal display panel 40. In this way, the result of photographing received from the imaging device 32 and the result of photographing recorded in the external recording medium 37 are displayed on the liquid crystal panel 40.

The components (shown in FIG. 1) of the electronic still camera 31 work as follows. The driving circuit 53 records the following set points in the memory. The pixel arrangement set point DD1 which indicates the order of arrangement of pixels in the liquid crystal display panel. The odd-number line initial phase set point DOP which indicates the spatial phase for the pixel as the scan starting terminal for the odd-number line.

The even-number line initial phase set point DEP which indicates the spatial phase for the pixel as the scan starting end for the even-number line.

The output sampling interval set point DSP which indicates the sampling cycle for the output image data D7. When the electronic still cameral 31 is turned on, these set points are set up in the display signal processing circuit 39.

In the driving circuit 53, the selector 54 sequentially selects and sends out the red, green, and blue color data constituting the image data D6 according to the pixel arrangement set point DD1. In other words, the color data is sequentially selected and sent out according to the order corresponding to the pixel arrangement in the liquid crystal display panel 40. In this embodiment, the pixel arrangement set point DD1 is so established as to correspond to the delta arrangement if the liquid crystal display panel 40 has color filters in delta arrangement and has different-color wiring. This construction permits the color data to be sequentially selected in the order of red, green, and blue for the odd-number line, or to be sequentially selected in the order of green, blue, and red for the even-number line, as shown in FIG. 5. Thus, the color data is sequentially selected in the order corresponding to the pixel arrangement in the liquid crystal display panel 40.

In the case where the liquid crystal display panel 40 is of stripe arrangement type or of delta arrangement type with same-color wiring, the pixel arrangement set point DD1 is established in correspondence with them. Thus, the color data is sequentially selected in the order of red, green, and blue for both the odd-number line and the even-number line. In this case, too, the color data is sequentially selected in the order corresponding to the pixel arrangement in the liquid crystal display panel.

The image data D8 has the color data sequentially time-shared and multiplexed in the order corresponding to the pixel arrangement as mentioned above. Subsequently, the image data D8 has its phase characteristics corrected for each color by the FIR filter 57 and its pixel value corrected by the normalizing operator 61, so that the spatial phase is established in correspondence to the pixel arrangement of the liquid crystal display panel 40. In other words, the phase correction is accomplished in the following manner. The phase difference from the corresponding color data which is output from the selector 54 is computed for each sample of the output image data D7 by means of the odd-number line initial phase set point DOP for the odd-number line, the even-number line initial phase set point DEP for the even-number line, and the output sampling interval set point DSP. The factor data for the FIR filter 57 is detected by means of the look-up table 59 so as to correct the phase difference, and this factor data is set up in the FIR filter 57. In this way, the electronic still camera 31 provides the liquid crystal display panel 40 with the image data D7 according to the spatial phase corresponding to the delta pixel arrangement. The resulting image has no uncomfortable appearance. It is also possible to drive the liquid crystal panel of stripe arrangement type by setting the DOP (or DEP) and DSP such that they correspond to the pixel arrangement. Thus the electronic still camera 31 can display the image by using the image data processing circuit in common for the liquid crystal display panels which differ in the arrangement of color filters.

When the user changes the direction of the liquid crystal display panel 40, the central processing unit 38 sends out an instruction for Vertical-inversion or Horizontal-inversion. In the case of Horizontal-inversion, the order of distribution of the image data to signal lines is inverted line by line in the liquid crystal display panel 40. Also, the order of selection of color data in the selector 54 is inverted and the phase correction in the resolution phase correcting circuit 55 is switched. Thus the correct image is displayed with the image data in which the color data is time-shared and multiplexed according to the order and spatial phase corresponding to Horizontal-inversion. In the case of Vertical-inversion, the order of selecting color data in the selector 54 is switched for the odd-number line and the even-number line and the phase correction is also switched accordingly. Thus the correct image is displayed also in the case of Vertical-inversion.

### (3) Embodiment 1—Effect

As mentioned above, Embodiment 1 is so designed as to sequentially select the color data and correct the phase characteristics. It also makes it possible to set up the order of selecting the color data and the phase characteristics to be corrected. Thus it permits the display image data processing circuit to be used in common for the liquid crystal display panels which differ in the arrangement of color filters.

To be concrete, the order of selection (that can be established) and the correction of phase characteristics are available for either the pixel arrangement of stripe type or the pixel arrangement of delta type. Consequently, the image data processing circuit for display can be used in common for the display panel with stripe arrangement and the display panel with delta arrangement.

The data for the order of arrangement and the initial phase relating to the correction of phase characteristics are set up in the register. And the color data is selected according to this set point and the phase relating to each pixel is detected to correct the phase characteristics according to this set point. The simple setting in this manner permits the image data processing circuit to be used in common for the display panels of stripe arrangement type or delta arrangement type.

### Embodiment 2

The above-mentioned Embodiment 1 is concerned with the driving of a liquid crystal display panel. The present invention is not limited in its application; it may be widely applied to a variety of flat display devices.

In the above-mentioned Embodiments, the present invention is applied to an electronic still camera. However, the present invention may be applied to a variety of image display devices such as video camera.

The present invention can be applied to an electronic still camera.

It should be understood by those skilled in the art that various modifications, combinations, sub-combinations and alterations may occur depending on design requirements and other factors insofar as they are within the scope of the appended claims or the equivalents thereof.

What is claimed is:

1. An image display device designed to display an image on the display unit including pixels arranged in a matrix pattern, comprising:
a selector configured to sequentially select red, green, and blue color data in a prescribed order and then send them out; and
a phase correcting circuit configured to correct and send out the phase of each color data sent out from said selector,
wherein said selector includes selection-order setting means for setting the order of selection in such a way that the order of selection corresponds to the arrangement of pixels in said display unit, and
wherein said phase correcting circuit includes characteristics setting means for setting the characteristics to correct the phase of said color data in such a way that the spatial phase of the said color data corresponds to the arrangement of pixels in said display unit.

2. The image display device as defined in claim 1, wherein the selector can change the order of selection according to the pixel arrangement in stripe pattern and the pixel arrangement of delta pattern, and
wherein the phase correcting circuit can set up the characteristics to correct the phase of the color data corresponding to the pixel arrangement in stripe pattern and the characteristics to correct the phase of the color data corresponding to the pixel arrangement in delta pattern.

3. The image display device as defined in claim 2,
wherein the selection-order setting means is a register in which the data of the order of arrangement is set up,
wherein the selector selects and sends out the color data sequentially on the basis of the value of the register which has been set up by the selection-order setting means,
wherein the characteristics setting means is a register in which is set up the spatial phase in the pixel at the scan starting end in the horizontal direction in the display unit for the even-number line and the odd-number line, and
wherein the phase correcting circuit comprises an output phase operator to detect the correcting factor for each pixel according to the value of the register set up by the characteristics setting means and an FIR filter to correct, according to the correcting factor, the color data output from the selector.

4. An image display device designed to send out image data to the display unit including pixels arranged in a matrix pattern, thereby displaying an image on said display unit, comprising:
a selector configured to sequentially select red, green, and blue color data in a prescribed order and then send them out; and
a phase correcting circuit configured to correct and send out the phase of each color data sent out from said selector,
wherein said selector includes selection-order setting means for setting the order of selection in such a way that the order of selection corresponds to the arrangement of pixels in said display unit, and
wherein said phase correcting circuit includes characteristics setting means for setting the characteristics to correct the phase of said color data in such a way that the spatial phase of the said color data corresponds to the arrangement of pixels in said display unit.

5. An image display device designed to display an image on the display unit including pixels arranged in a matrix pattern, comprising:
a selector configured to sequentially select red, green, and blue color data in a prescribed order and then send them out; and
a phase correcting circuit configured to correct and send out the phase of each color data sent out from said selector,
wherein said selector includes a selection-order setting unit configured to set the order of selection in such a way that the order of selection corresponds to the arrangement of pixels in said display unit, and
wherein said phase correcting circuit includes a characteristics setting unit configured to set the characteristics to correct the phase of said color data in such a way that the spatial phase of the said color data corresponds to the arrangement of pixels in said display unit.

6. An image display device designed to send out image data to the display unit including pixels arranged in a matrix pattern, thereby displaying an image on said display unit, comprising:
a selector configured to sequentially select red, green, and blue color data in a prescribed order and then send them out; and
a phase correcting circuit configured to correct and send out the phase of each color data sent out from said selector,
wherein said selector includes a selection-order setting unit configured to set the order of selection in such a way that the order of selection corresponds to the arrangement of pixels in said display unit, and
wherein said phase correcting circuit includes a characteristics setting unit configured to set the characteristics to correct the phase of said color data in such a way that the spatial phase of the said color data corresponds to the arrangement of pixels in said display unit.

7. An image displaying method for displaying an image on the display unit including pixels arranged in a matrix pattern, comprising the steps of:
sequentially selecting red, green, and blue color data in a prescribed order to send out the result; and
correcting the phase of each color data sent out from said selector and sends out the result,
wherein said selecting step includes setting the order of selection in such a way that the order of selection corresponds to the arrangement of pixels in said display unit, and
wherein said phase correcting step includes correcting the spatial phase of said color data in such a way that the spatial phase of said color data corresponds to the arrangement of pixels in said display unit.

8. An image displaying method for sending image data to a display unit including pixels arranged in a matrix pattern and displaying an image on said display unit, comprising the steps of:
sequentially selecting red, green, and blue color data in a prescribed order and sends out the result;
correcting the phase of each color data sent out from said selector; and
sending out the corrected phase of each color data,
wherein said selecting step includes setting the order of selection in such a way that the order of selection corresponds to the arrangement of pixels in said display unit, and
wherein said correcting step includes correcting the spatial phase of said color data in such a way that the spatial phase of said color data corresponds to the arrangement of pixels in said display unit.
